(19) United States
(12) Patent Application Publication
(10) Pub. No.: US 2022/0092423 A1
(43) Pub. Date: Mar. 24, 2022

(54) INPUT ORDERING NEURAL NETWORK DECOMPOSITION

(71) Applicant: International Business Machines Corporation, Armonk, NY (US)

(72) Inventors: Venkatesan T. Chakaravarthy, Munirka (IN); Anamitra Roy Choudhury, Vasant Kunj (IN); Saurabh Goyal, New Delhi (IN); Saurabh Manish Raje, Gurgaon (IN); Yogish Sabharwal, Gurgaon (IN); ASHISH VERMA, Nanuet, NY (US)

(21) Appl. No.: 17/026,589

(22) Filed: Sep. 21, 2020

(51) Int. Cl. G06N 3/08; G06N 3/04; G06F 17/16; G06K 9/62

(52) U.S. Cl. CPC G06N 3/082; G06K 9/6218; G06F 17/16; G06N 3/04

(57) ABSTRACT

One or more computer processors decompose a weight matrix associated with a neural network utilizing a permutation dependent decomposition. The one or more computer processors regenerate a recovered matrix utilizing the decomposed weight matrix. The one or more computer processors reduce an error between the decomposed weight matrix and regenerated recovered matrix.

### BACKGROUND

The present invention relates generally to the field of machine learning, and more particularly to neural network compression.

Neural networks (NNs) are computing systems inspired by biological neural networks. NNs are not simply algorithms, but rather a framework for many different machine learning algorithms to work together and process complex data inputs. Such systems “learn” to perform tasks by considering examples, generally without being programmed with any task-specific rules. For example, in image recognition, NNs learn to identify images that contain cats by analyzing example images that are correctly labeled as “cat” or “not cat” and using the results to identify cats in other images. NNs accomplish this without any prior knowledge about cats, for example, that cats have fur, tails, whiskers, and pointy ears. Instead, NNs automatically generate identifying characteristics from the learning material. NNs are based on a collection of connected units or nodes called artificial neurons, which loosely model the neurons in a biological brain. Each connection, like the synapses in a biological brain, can transmit a signal from one artificial neuron to another. An artificial neuron that receives a signal can process the signal and then transfer the signal to additional artificial neurons.

In common NN implementations, the signal at a connection between artificial neurons is a real number, and the output of each artificial neuron is computed by some non-linear function of the sum of its inputs. The connections between artificial neurons are called ‘edges’. Artificial neurons and edges typically have a weight that adjusts as learning proceeds. The weight increases or decreases the strength of the signal at a connection. Artificial neurons may have a threshold such that the signal is only sent if the aggregate signal crosses that threshold. Typically, artificial neurons are aggregated into layers. Different layers may perform different kinds of transformations on their inputs. Signals travel from the first layer (the input layer), to the last layer (the output layer), possibly after traversing the layers multiple times.

In linear algebra, the singular value decomposition (SVD) is a factorization of a real or complex matrix that generalizes the eigendecomposition of a square normal matrix to any m×n matrix via an extension of the polar decomposition.

### SUMMARY

Embodiments of the present invention disclose a computer-implemented method, a computer program product, and a system. The computer-implemented method includes one or more computer processers decomposing a weight matrix associated with a neural network utilizing a permutation dependent decomposition. The one or more computer processors regenerate a recovered matrix utilizing the decomposed weight matrix. The one or more computer processors reduce an error between the decomposed weight matrix and regenerated recovered matrix.

### BRIEF DESCRIPTION OF THE DRAWINGS

FIG. 1 is a functional block diagram illustrating a computational environment, in accordance with an embodiment of the present invention;

FIG. 2 is a flowchart depicting operational steps of a program, on a server computer within the computational environment of FIG. 1, for compressing a neural network through iterative permutated decompositions, in accordance with an embodiment of the present invention;

FIG. 3 is an exemplary diagram of a tensor decomposition and permutation, in accordance with an embodiment of the present invention;

FIG. 4 is an exemplary diagram of a matrix permutation, in accordance with an embodiment of the present invention;

FIG. 5 is an exemplary diagram of a bipartite graph of input matrix and recovered matrix, in accordance with an embodiment of the present invention;

FIG. 6 is an exemplary diagram depicting operational steps detailed in FIG. 2, in accordance with an embodiment of the present invention;

FIG. 7 is an exemplary table, in accordance with an embodiment of the present invention; and

FIG. 8 is a block diagram of components of the server computer, in accordance with an embodiment of the present invention.

### DETAILED DESCRIPTION

Deep neural networks are used extensively for a variety of artificial intelligence applications such as computer vision, speech recognition and natural language processing. Increasingly practitioners are utilizing these deep learning models on mobile devices (e.g., mobile phones) and other edge devices such as TOT (Internet of Things). Traditionally, as datasets increase in size, so does the number of layers and the number of parameters for associated deep neural networks due to the increased amount of learning (e.g., training) needed to absorb and process the data. For example, the following are common models and associated model sizes AlexNet, (˜240 MB), VGGNet-16 (˜550 MB), Bert-Base (˜400 MB), and Bert-Large (˜1.3 GB). Such large models are difficult to be used in low resource environments due to the associated computational requirements. Even when inferencing/training is completed on the cloud, computational resources must be efficiently utilized to keep the cost of processing at a minimum for the cloud vendor. Traditionally, developers may utilize multiple customized deep learning models (e.g., for various domains and users) that need to be kept in memory in order to provide a low response time, thus increasing computational requirements.

Embodiments of the present invention compress a neural network for a target dataset in order to achieve higher inference performance. Embodiments of the present invention decompose a weight matrix/tensor (M) of a neural network. Embodiments of the present invention regenerate a recovered matrix/tensor (R) from the decomposition of the weight matrix/tensor (M). Embodiments of the present invention permute the rows of M (i.e., in the case of matrices) or unfolds (i.e., in the case of tensors) to minimize the error between the M and R. Embodiments of the present invention utilizes a permutation dependent decomposition method such as train decomposition to decompose the embedding the fully connected layers of the network. Embodiments of the present invention utilizes Euclidean distance as an error metric. Embodiments of the present invention permute the rows of M utilizing a minimum weight perfect bipartite matching on the complete bipartite graph defined with rows of M on one side, rows of R on another side, and adding edges with weight as the distance between two nodes. Embodiments of the present invention cluster rows of M and assign rows of R to the nearest cluster while performing approximate matching within each cluster. Embodiments of the present invention reduce dimensionality of M and R by applying matching over the reduced matrices/tensors. Embodiments of the present invention iteratively performs the above embodiments till the distance between rows of M and R converge to a desired level of accuracy. Some embodiments of the present invention recognize that the computational requirements of a neural network are reduced by iteratively compressing one or more associated layers while retaining accuracy levels utilizing the embodiments described above. Embodiments of the present invention reduce parameter redundancy in models by using the low rank and sparsity characteristics of weight matrices or tensors and therefore suitable for applications in mobile systems and edge devices. Implementation of embodiments of the invention may take a variety of forms, and exemplary implementation details are discussed subsequently with reference to the Figures.

The present invention will now be described in detail with reference to the Figures.

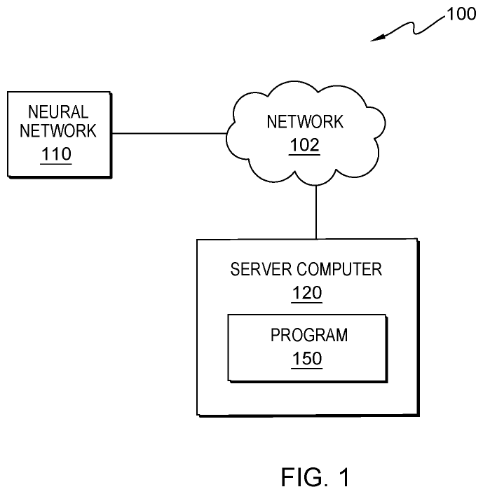

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

Neural network 110 is representative of a model utilizing deep learning techniques to train, calculate weights, ingest inputs, and output a plurality of solution vectors. In an embodiment, neural network 110 is comprised of any combination of deep learning model, technique, and algorithm such as transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. In the depicted embodiment, neural network 110 is a neural network (NN) trained utilizing supervised training methods.

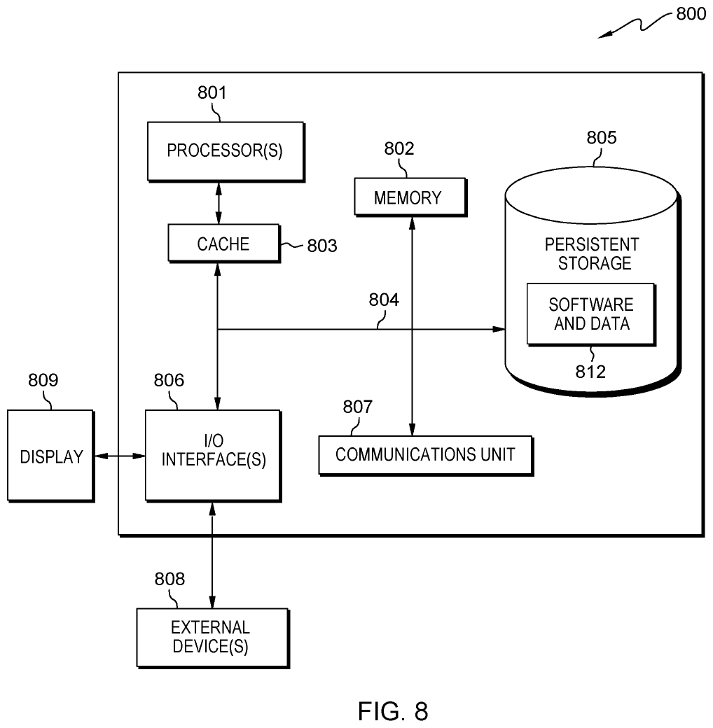

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes program 150. In other embodiments, server computer 120 may contain other applications, databases, programs, etc. which have not been depicted in computational environment 100. Server computer 120 may include internal and external hardware components, as depicted, and described in further detail with respect to FIG. 8.

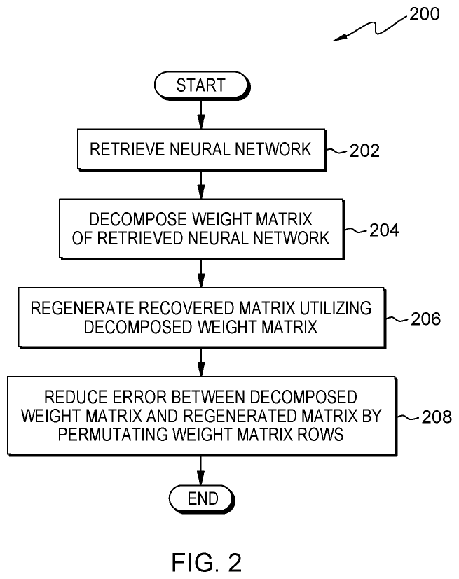

Program 150 is a program for compressing a neural network through iterative permutated decompositions. In an embodiment, program 150 reduces the error of the decomposition by permuting the rows of a matrix M to get a new matrix M′ and applying the decomposition process over the permuted matrix M′ (instead of M). In various embodiments, program 150 may implement the following steps: decompose a weight matrix associated with a neural network utilizing a permutation dependent decomposition; regenerate a recovered matrix utilizing the decomposed weight matrix; and reduce an error between the decomposed weight matrix and regenerated recovered matrix. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. Program 150 is depicted and described in further detail with respect to FIG. 2.

The present invention may contain various accessible data sources that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for compressing a neural network through iterative permutated decompositions, in accordance with an embodiment of the present invention.

Program 150 retrieves a neural network (step 202). In an embodiment, program 150 initiates responsive to a user inputting one or more neural networks. In another embodiment, program 150 monitors a datastore containing one or more neural networks and, subsequently, compresses the one or more contained neural networks. In another embodiment, program 150 initiates responsive to a neural network training or retraining.

Program 150 decomposes a weight matrix of the retrieved neural network (step 204). In an embodiment, program 150 decomposes a weight matrix associated with the retrieved neural network. In an embodiment, program 150 extracts a fully connected layer associated with the retrieved neural network consisting of a linear transformation of a high-dimensional input signal to a high-dimensional output signal with a large dense weight matrix defining the transformation. Embodiments of the present invention recognize that a weight matrix of the fully connected layer is highly redundant and by restricting its matrix rank it is possible to greatly reduce the number of parameters without significant drop in the predictive accuracy. In various embodiments, program 150 decomposes one or more layers (e.g., fully connected and embedding) associated with the retrieved neural network into a multilinear format such as Tensor-Train (TT). In various embodiments, program 150 utilizes any permutation dependent decomposition method such as the train decomposition of the embedding and the fully connected layers of the network. In a further embodiment, program 150 utilizes train decomposition to decompose said layers into a plurality of sub-matrices and/or tensors. In other embodiments, program 150 utilizes Tensor Train (TT), Tensor Ring (TR) or Hierarchical Tucker (HT) decomposition. The Tensor-Train decomposition of an N-dimensional tensor Q of size L₁×L₂× . . . ×L_{N} is a sequence of cores [G₁, G₂, . . . , G_{N}] wherein G₁ is a matrix of size L₁×r, G₂ is a matrix of size r×L_{N} and the other components Gⱼ are three-dimensional tensors of size Lⱼ×r×r, with r being the rank of the decomposition. The decomposition satisfies the property that for any index (i₁, i₂, . . . , i_{N}), the element Q[i₁, i₂, . . . , i_{N}] is given by the sequence of matrix multiplications: Q[i₁, i₂, . . . , i_{N}]=G₁[i₁,:]×G₂[i₂,:,:]× . . . ×G_{N-1}[i_{N-1},:,:]×G_{N}[:,i_{N}], where the value r is the TT-rank of the decomposition.

An approximate Tensor-Train decomposition of a tensor P of size L₁×L₂× . . . ×L_{N} comprises of a tensor Q of size L₁×L₂× . . . ×L_{N} and an associated train decomposition [G₁, G₂, . . . , G_{N}] such that Q is an approximation of P. In this case, Q is called the recovered tensor. The approximate decomposition can be obtained using the above decomposition where the TT-rank r controls the trade-off between memory and computational efficiency. In an embodiment, M is a matrix of size (nrow, ncol) with nrow=I₁I₂ . . . I_{N} and ncol=J₁J₂ . . . J_{N}. The tensor-folding of M is a tensor P of size L₁×L₂× . . . ×L_{N} with each Lⱼ=IⱼJⱼ such that for any indices row=(i₁, i₂, . . . , i_{N}) and col=(j₁, j₂, . . . , j_{N}): P[(i₁j₁, i₂j₂, . . . , i_{N}j_{N})=M[row, col]. In a further embodiment, program 150 unfolds a tensor, where program 150 reads a tensor element in such a way as to obtain a matrix instead of a tensor.

Program 150 constructs a recovered matrix utilizing the decomposed weight matrix (step 206). In an embodiment, program 150 regenerates a recovered (i.e., recovery) matrix utilizing the decomposed weight matrix. In various embodiments, the recovered matrix is an approximation under an identity mapping from the rows of the input matrix (M) to the rows of the recovery matrix (R). As discussed in step 204, program 150 train decomposes matrix M by calculating tensor-folding P; calculating an approximate train-decomposition [G₁, G₂, . . . , G_{N}] of P; calculating Q as the recovered tensor of the decomposition be obtained using the equations detailed in step 204, and unfolding Q to obtain a matrix R of size (nrow, ncol) using the reverse of R[row, col]=Q[(i₁j₁, i₂j₂, . . . , i_{N}j_{N}) (i.e., the recovered matrix).

Program 150 reduces an error between the decomposed matrix and the recovered matrix by permutating the decomposed weight matrix rows (step 208). In an embodiment, program 150 reduces an error rate between the decomposed matrix and the recovered matric by permutating the decomposed weight matrix rows. In an embodiment, the error rate is any distance measure such as Euclidean distance. In an embodiment, program 150 computes an error (e.g., distance) in the train decomposition of M by comparing the rows of M with the corresponding rows of the recover matrix R.

In an embodiment, program 150 determines a permutation by performing a minimum weight perfect bipartite matching on a complete bipartite graph defined with a plurality of rows of a input matrix (M) on one side, a plurality of rows of a recovery matrix (R) on the opposite side, and adds a plurality of edges, where each edge is associated with a row in each plurality of rows (i.e., weight and recovered matrix), with a weight as the distance between the rows. In this embodiment, for each pair of rows (a, b), where a is from M and b is from R, program 150 adds an edge with the Euclidean distance between the two rows as the weight of the edge. Then program 150 computes a minimum weight perfect bipartite matching where the matching π maps each row x of M to some row y=π(x) of R. In a further embodiment, program 150 permutes the rows of M according to the matching π by moving the row x to the position π(x) where the output is a matrix M′. In an embodiment, program 150 repeats the process above by taking M=M′ until error converges. In this embodiment, said procedure terminates with outputting a permutation π and a recovered matrix R′. In another embodiment, program 150 calculates a recovered matrix R for the original matrix M by permuting the rows of R′ via the inverse permutation π⁻¹.

In an embodiment, program 150 utilizes clustering to find a permutation. In this embodiment, program 150 utilizes clustering heuristics, such as clustering models, to cluster one or more rows of M into T clusters and compute cluster centroids in order to assign rows of R to the nearest cluster while ensuring each cluster has equal number of rows of M and R. Here, program 150 approximates bipartite matching within each cluster. In an embodiment, program 150 accelerates the permutation process by utilizing at least one of the following: approximate Euclidean matching, clustering rows of M and assigning rows of R to the nearest cluster and performing approximate matching within each cluster; and reducing dimensionality of M and R by applying matching over the reduced matrices/tensors. In an embodiment, program 150 utilizes the determined permutation for improving the error for any permutation-dependent decomposition, wherein permutating the rows of the input matrix leads to different errors. In an embodiment, program 150 iteratively repeats steps 204, 206, and 208 until the distance between rows of M and R converge to a desired level of accuracy resulting in a compressed neural network.

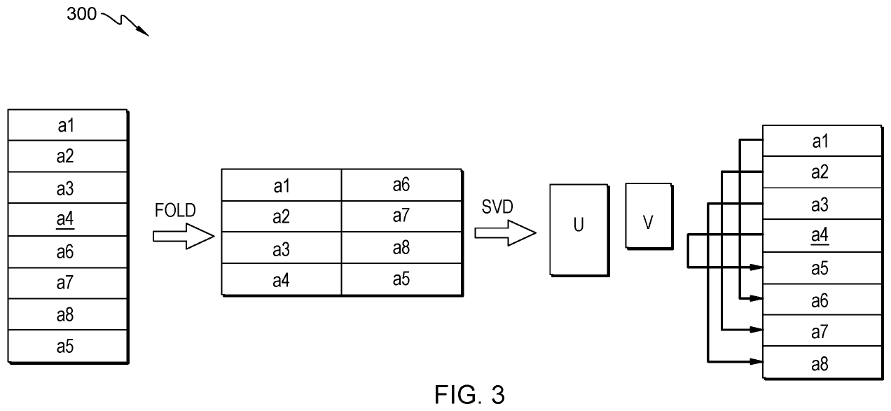

FIG. 3 depicts example diagram 300, in accordance with an embodiment of the present invention. Example diagram 300 depicts program 150 unfolding a tensor containing rows a1, . . . , a8 into a matrix. Subsequently, program 150 utilizes SVD to decompose the unfolded tensor matrix into two submatrices (i.e., U and V). Program 150 then calculated a permutation and executes said permutation on the rows: a1a6, a2a7, a3a8, and a4a5.

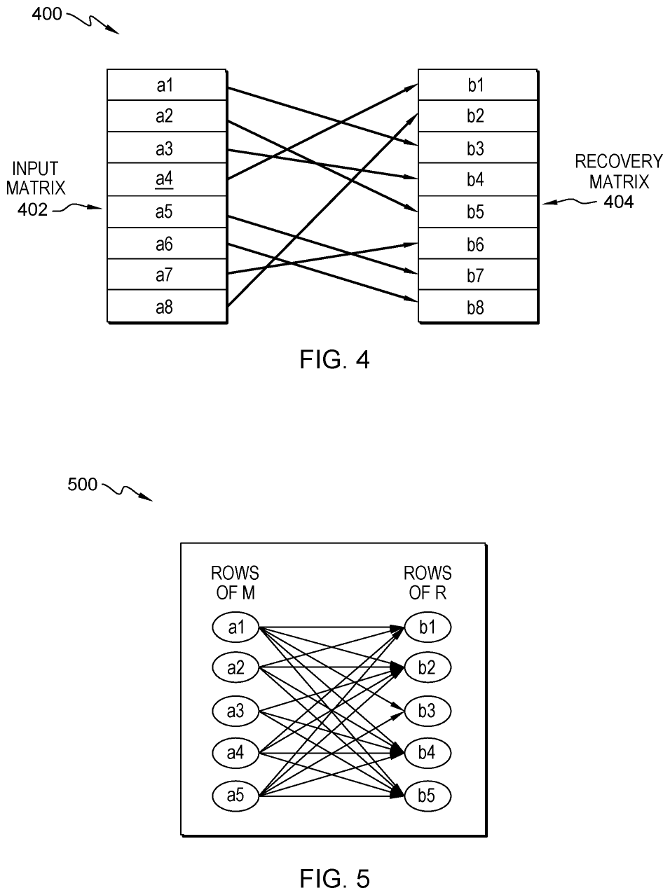

FIG. 4 depicts example diagram 400, in accordance with an embodiment of the present invention. Example diagram 400 contains input matrix 402, a matrix representing one or more layers, and recover matrix 404, a recovered matrix constructed utilizing a train decomposed input matrix 402. Example diagram 400 depicts program 150 permutating input matrix 402 into recovered matrix 404 based on a bipartite graphing.

FIG. 5 depicts example diagram 500, in accordance with an embodiment of the present invention. Example diagram 500 depicts program 150 constructing a complete bipartite graph of the rows contained in input matrix (M) and the rows contained in recovered matrix (R).

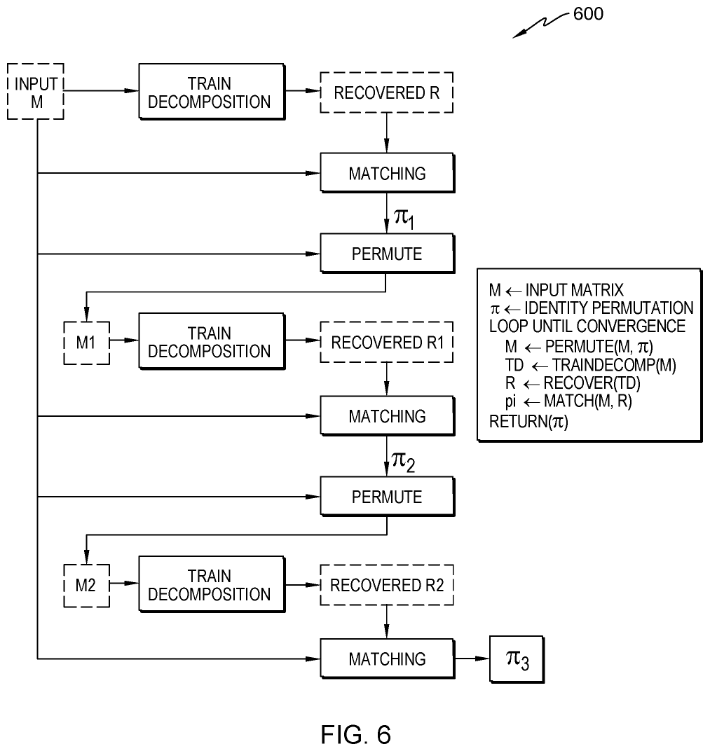

FIG. 6 depicts example diagram 600, in accordance with an embodiment of the present invention. Example diagram 600 depicts embodiment of the process detailed in flowchart 200 in FIG. 2. Example diagram 600 depicts program 150 initiates a train decomposition on Input (M) matrix and constructing a corresponding Recovered (R) matrix. Program 150, subsequently, performs a bipartite graph to match the rows of M to the rows of R. Responsively, program 150 performs row permutation utilizing the matched rows. Program 150 iteratively continues the above process until the distance between rows of M and R converge to a desired level of accuracy.

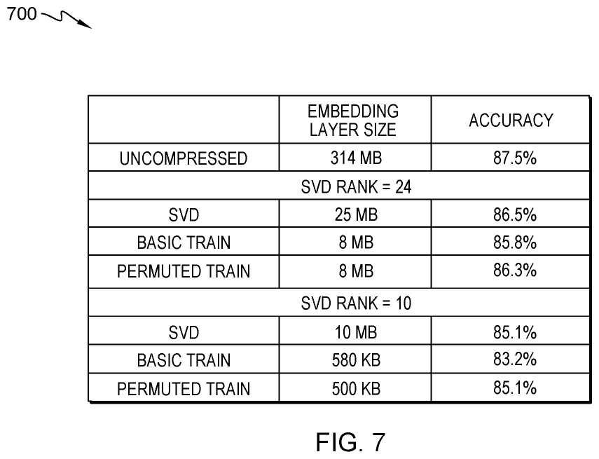

FIG. 7 depicts example table 700, in accordance with an embodiment of the present invention. Example table 700 illustrates the compression efficacy of program 150 over traditional compression methods while retaining relative high levels of accuracy. Example table 700 shows a uncompressed embedding layer associated with a neural network requiring 314 megabytes (MB) of storage with an accuracy of 87.5%, an singular value decomposition (SVD) rank 24 compressed embedding layer requiring 25 MB with an accuracy of 86.5%, and an SVD rank 10 compressed embedding layer requiring 10 MB with an accuracy of 85.1%. Example table 700 further shows program 150 (i.e., permuted train) requiring 8 MB with and accuracy of 86.3% at rank 24 and 500 kilobyte (KB) with and accuracy of 85.1% at rank 10. Example table 700 demonstrates that program 150 (i.e., permuted train) retains relative accuracy while retaining relative compression rates.

FIG. 8 depicts block diagram 800 illustrating components of server computer 120 in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Server computer 120 each include communications fabric 804, which provides communications between cache 803, memory 802, persistent storage 805, communications unit 807, and input/output (I/O) interface(s) 806. Communications fabric 804 can be implemented with any architecture designed for passing data and/or control information between processors (such as microprocessors, communications, and network processors, etc.), system memory, peripheral devices, and any other hardware components within a system. For example, communications fabric 804 can be implemented with one or more buses or a crossbar switch.

Memory 802 and persistent storage 805 are computer readable storage media. In this embodiment, memory 802 includes random access memory (RAM). In general, memory 802 can include any suitable volatile or non-volatile computer readable storage media. Cache 803 is a fast memory that enhances the performance of computer processor(s) 801 by holding recently accessed data, and data near accessed data, from memory 802.

Program 150 may be stored in persistent storage 805 and in memory 802 for execution by one or more of the respective computer processor(s) 801 via cache 803. In an embodiment, persistent storage 805 includes a magnetic hard disk drive. Alternatively, or in addition to a magnetic hard disk drive, persistent storage 805 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 805 may also be removable. For example, a removable hard drive may be used for persistent storage 805. Other examples include optical and magnetic disks, thumb drives, and smart cards that are inserted into a drive for transfer onto another computer readable storage medium that is also part of persistent storage 805. Software and data 812 can be stored in persistent storage 805 for access and/or execution by one or more of the respective processors 801 via cache 803.

Communications unit 807, in these examples, provides for communications with other data processing systems or devices. In these examples, communications unit 807 includes one or more network interface cards. Communications unit 807 may provide communications through the use of either or both physical and wireless communications links. Program 150 may be downloaded to persistent storage 805 through communications unit 807.

I/O interface(s) 806 allows for input and output of data with other devices that may be connected to server computer 120. For example, I/O interface(s) 806 may provide a connection to external device(s) 808, such as a keyboard, a keypad, a touch screen, and/or some other suitable input device. External devices 808 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 805 via I/O interface(s) 806. I/O interface(s) 806 also connect to a display 809.

Display 809 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q #, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG) illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
decomposing, by one or more computer processors, a weight matrix associated with a neural network utilizing a permutation dependent decomposition;
regenerating, by one or more computer processors, a recovered matrix utilizing the decomposed weight matrix; and
reducing, by one or more computer processors, an error between the decomposed weight matrix and regenerated recovered matrix.

2. The computer-implemented method of claim 1, wherein reducing the error between the decomposed weight matrix and the regenerated recovered matrix, comprises:
determining, by one or more computer processors, a permutation utilizing a minimum weight perfect bipartite matching on a complete bipartite graph;
adding, by one or more computer processors, a plurality of edges, where each edge in the plurality of edges is associated with a row in a plurality of rows of the weight matrix and a row in a plurality of rows of the recovered matrix with weight as a distance between the plurality of rows of the weight matrix and the plurality of rows of the recovered matrix; and
permutating, by one or more computer processors, the plurality of rows of the weight matrix with the plurality of rows of the recovered matrix utilizing the added plurality of edges.

3. The computer-implemented method of claim 2, further comprising:
clustering, by one or more computer processors, the plurality of rows of the weight matrix and the plurality of rows of the recovered matrix to a nearest cluster; and
performing, by one or more computer processors, an approximate matching within each cluster.

4. The computer-implemented method of claim 2, further comprising:
clustering, by one or more computer processors, the plurality of rows of the weight matrix into a plurality of clusters; and
assigning, by one or more computer processors, the plurality of rows of the recovered matrix to a nearest cluster while ensuring each cluster has an equal number of rows by computing a respective centroid for each cluster in the plurality of cluster.

5. The computer-implemented method of claim 1, further comprising:
computing, by one or more computer processors, an error in the decomposition of the weight matrix by comparing a plurality of rows of the weight matrix with a corresponding plurality of rows of the recovered matrix.

6. The computer-implemented method of claim 1, wherein the recovered matrix is an approximation under an identity mapping from the plurality of rows of the weight matrix to the plurality of rows of the recovered matrix.

7. The computer-implemented method of claim 1, wherein the decomposition is a train decomposition.

8. A computer program product comprising:
one or more computer readable storage media and program instructions stored on the one or more computer readable storage media, the stored program instructions comprising:
program instructions to decompose a weight matrix associated with a neural network utilizing a permutation dependent decomposition;
program instructions to regenerate a recovered matrix utilizing the decomposed weight matrix; and
program instructions to reduce an error between the decomposed weight matrix and regenerated recovered matrix.

9. The computer program product of claim 8, wherein the program instructions, to reduce the error between the decomposed weight matrix and the regenerated recovered matrix, comprise:
program instructions to determine a permutation utilizing a minimum weight perfect bipartite matching on a complete bipartite graph;
program instructions to add a plurality of edges, where each edge in the plurality of edges is associated with a row in a plurality of rows of the weight matrix and a row in a plurality of rows of the recovered matrix with weight as a distance between the plurality of rows of the weight matrix and the plurality of rows of the recovered matrix; and
program instructions to permutate the plurality of rows of the weight matrix with the plurality of rows of the recovered matrix utilizing the added plurality of edges.

10. The computer program product of claim 9, wherein the program instructions, stored on the one or more computer readable storage media, further comprise:
program instructions to cluster the plurality of rows of the weight matrix and the plurality of rows of the recovered matrix to a nearest cluster; and
program instructions to perform an approximate matching within each cluster.

11. The computer program product of claim 9, wherein the program instructions, stored on the one or more computer readable storage media, further comprise:
program instructions to cluster the plurality of rows of the weight matrix into a plurality of clusters; and
program instructions to assign the plurality of rows of the recovered matrix to a nearest cluster while ensuring each cluster has an equal number of rows by computing a respective centroid for each cluster in the plurality of cluster.

12. The computer program product of claim 8, wherein the program instructions, stored on the one or more computer readable storage media, further comprise:
program instructions to compute an error in the decomposition of the weight matrix by comparing a plurality of rows of the weight matrix with a corresponding plurality of rows of the recovered matrix.

13. The computer program product of claim 8, wherein the recovered matrix is an approximation under an identity mapping from the plurality of rows of the weight matrix to the plurality of rows of the recovered matrix.

14. The computer program product of claim 8, wherein the decomposition is a train decomposition.

15. A computer system comprising:
one or more computer processors;
one or more computer readable storage media; and
program instructions stored on the computer readable storage media for execution by at least one of the one or more processors, the stored program instructions comprising:
program instructions to decompose a weight matrix associated with a neural network utilizing a permutation dependent decomposition;
program instructions to regenerate a recovered matrix utilizing the decomposed weight matrix; and
program instructions to reduce an error between the decomposed weight matrix and regenerated recovered matrix.

16. The computer system of claim 15, wherein the program instructions, to reduce the error between the decomposed weight matrix and the regenerated recovered matrix, comprise:
program instructions to determine a permutation utilizing a minimum weight perfect bipartite matching on a complete bipartite graph;
program instructions to add a plurality of edges, where each edge in the plurality of edges is associated with a row in a plurality of rows of the weight matrix and a row in a plurality of rows of the recovered matrix with weight as a distance between the plurality of rows of the weight matrix and the plurality of rows of the recovered matrix; and
program instructions to permutate the plurality of rows of the weight matrix with the plurality of rows of the recovered matrix utilizing the added plurality of edges.

17. The computer system of claim 16, wherein the program instructions, stored on the one or more computer readable storage media, further comprise:
program instructions to cluster the plurality of rows of the weight matrix and the plurality of rows of the recovered matrix to a nearest cluster; and
program instructions to perform an approximate matching within each cluster.

18. The computer system of claim 16, wherein the program instructions, stored on the one or more computer readable storage media, further comprise:
program instructions to cluster the plurality of rows of the weight matrix into a plurality of clusters; and
program instructions to assign the plurality of rows of the recovered matrix to a nearest cluster while ensuring each cluster has an equal number of rows by computing a respective centroid for each cluster in the plurality of cluster.

19. The computer system of claim 15, wherein the program instructions, stored on the one or more computer readable storage media, further comprise:
program instructions to compute an error in the decomposition of the weight matrix by comparing a plurality of rows of the weight matrix with a corresponding plurality of rows of the recovered matrix.

20. The computer system of claim 15, wherein the recovered matrix is an approximation under an identity mapping from the plurality of rows of the weight matrix to the plurality of rows of the recovered matrix.
